(19) United States
(12) Patent Application Publication
(10) Pub. No.: US 2019/0017573 A1
(43) Pub. Date: Jan. 17, 2019

(54) DRIVE TRAIN DEVICE HAVING AN ELECTRIC MOTOR

(71) Applicant: DAIMLER AG, Stuttgart (DE)

(72) Inventors: Tobias SCHILDER, Filderstadt (DE); Josep Maria BOU ROMANO, Stuttgart (DE); Klaus RIEDL, Tübingen (DE)

(21) Appl. No.: 16/065,212

(22) PCT Filed: Dec. 16, 2016
(86) PCT No.: PCT/EP2016/002117

§ 371 Date: Jun. 22, 2018

(30) Foreign Application Priority Data
Dec. 24, 2015 (DE) 10 2015 016 939.4

(51) Int. Cl. F16H 3/54; B60K 1/04

(52) U.S. Cl. CPC F16H 3/54; B60K 2001/001; B60K 1/04

(57) ABSTRACT

A drive train device includes at least one electric motor, at least one axle drive, and a transmission arranged between the electric motor and the axle drive. The transmission has exactly one planetary gear stage, one braking unit, and one clutch unit. The transmission is provided, at least in terms of design, for the selection of two powershiftable transmission gears.

### BACKGROUND AND SUMMARY

Exemplary embodiments of the invention relate to a drive train device having an electric motor and a transmission.

U.S. Pat. No. 9,062,744 B2 discloses a drive train device having an electric motor and a transmission.

PCT International Patent Publication No. WO 2014029651 A1 discloses a drive train device comprising an electric motor, a final drive, and a transmission arranged between the electric motor and the final drive, the transmission comprising exactly one planetary gear stage, a braking unit, and a clutch unit, and being provided for selecting two power-shiftable gear ratios.

Exemplary embodiments of the invention are directed to providing a compact drive train device.

The starting point is a drive train device having at least one electric motor, at least one final drive, and a transmission arranged between the electric motor and the final drive, which transmission comprises exactly one planetary gear stage, a braking unit and a clutch unit, and is provided, at least in terms of design, for selecting two power-shiftable gear ratios. This provides a drive train device for an electromotive drive and allows a compact design. In this context, a “planetary gear stage” should be understood in particular as a gear stage having at least one planetary gear train provided for introducing, transmitting and/or diverting driving power. In this context, a “planetary gear train” should be understood in particular as a gear train comprising exactly one sun gear that interacts with at least one planet carrier and at least one internal gear, exactly one planet carrier that interacts with at least one sun gear and at least one internal gear, and/or exactly one internal gear that interacts with at least one sun gear and at least one planet carrier. A “braking unit” should be understood in particular as a unit having at least two coupling elements that can rotate relative to one another and that are provided for being non-rotatably interconnected, one of the coupling elements being fixed to the housing. A “clutch unit” should be understood in particular as a unit having at least two coupling elements that can rotate and that are provided for being interconnected for conjoint rotation. “Provided” should be understood to mean in particular specially designed and/or equipped.

According to the invention, the planetary gear stage comprises an internal gear that is permanently coupled to the electric motor by a spur-gear coupling. By using the internal gear for coupling to the electric motor, a compact embodiment can be achieved. In this context, “permanently coupled” should be understood to mean in particular that the electric motor comprises a rotor that is permanently connected to the internal gear by a non-shiftable connector, such as a shaft or a gear stage.

For this purpose, the internal gear preferably comprises spur teeth on the outer periphery thereof, by means of which teeth the permanent coupling to the electric motor is provided.

It is further proposed for the planetary gear stage to comprise a planet carrier that is permanently coupled to the final drive. Power provided by the electric motor can thus be effectively diverted from the planetary gear stage. An advantageous arrangement of the braking unit is also possible.

In particular, the planetary gear stage comprises a sun gear, and the braking unit fixes the sun gear to the housing. This provides a simple shifting possibility for selecting the two forward gear ratios.

The clutch unit is provided for locking the planetary gear stage. In conjunction with the braking unit, the two forward gear ratios can thus be easily provided by means of the planetary gear stage. “Locking the planetary gear stage” should be understood to mean in particular that the sun gear, the planet carrier and the internal gear of the planetary gear stage are interconnected for conjoint rotation, the result being that, in an operating state of this type, they always rotate in the same direction and at the same speed.

A coupling element of the clutch unit is preferably arranged radially within an outer periphery of the internal gear, which results in a compact design.

In a preferred embodiment, the braking unit is designed to engage interlockingly. Drag loss can therefore be kept low, which allows power loss within the planetary gear stage to be reduced. In this case, an “interlockingly engaging braking unit” should be understood in particular as a braking unit comprising teeth and/or claws for connecting the coupling elements thereof or for linking the coupling element thereof, which teeth and/or claws mutually interlockingly engage so as to produce a connection for conjoint rotation, a power flow being transmitted at least mainly by means of an interlocking connection in a completely closed state. The interlockingly engaging braking unit is preferably designed as a claw brake, and/or comprises a sliding sleeve for producing the interlocking connection. The braking unit is preferably designed without a synchronizer, but can in principle also comprise a synchronizer.

The clutch unit is preferably designed to engage frictionally. As a result, it is easy to power-shift the gear ratios. In this case, a “frictionally engaging clutch unit” should be understood in particular as a clutch unit comprising at least two friction partners for connecting the coupling elements thereof or for linking the coupling element thereof, which friction partners frictionally abut one another so as to produce a connection for conjoint rotation, a power flow being transmitted at least mainly by means of an interlocking connection in a completely closed state. The frictionally engaging clutch unit is preferably designed as a disc clutch or a multi-plate clutch.

According to the invention, the transmission comprises at least a first gear stage. By means of the additional gear stage, a compact embodiment can be achieved, which in particular allows an advantageous arrangement of the electric motor with respect to the planetary gear stage. An advantageous transmission ratio between the electric motor and the final drive can also be achieved. A “gear stage” should be understood in particular as a non-shiftable pair of gearwheels.

The gear stage preferably comprises a spur gear in which the planetary gear stage is integrated. A particularly compact embodiment can thus be achieved. In this context, “integrated” should be understood to mean in particular that the spur gear spans an installation space in which in particular the planet gears and the sun gear of the planetary gear stage are arranged. The spur gear of the gear stage is preferably arranged coaxially with respect to the internal gear of the planetary gear stage, and is connected to the internal gear for conjoint rotation. The spur gear of the gear stage is particularly preferably integral with the internal gear of the planetary gear stage, i.e., the internal gear is in the form of a one-part or multi-part ring that comprises teeth on the inner periphery thereof for forming the internal gear, and comprises teeth on the outer periphery thereof for forming the spur gear.

The transmission preferably comprises a second gear stage operatively arranged between the planetary gear stage and the final drive, and which comprises a first gearwheel permanently connected to the planet carrier for conjoint rotation, and a second gearwheel associated with the final drive.

### BRIEF DESCRIPTION OF THE DRAWING FIGURES

Further advantages can be found in the following description of the drawings. A plurality of embodiments of the invention is shown in the drawings. The drawings, the description of the drawings and the claims contain numerous features in combination. A person skilled in the art will expediently also consider the features individually and combine them to form meaningful further combinations.

In the drawings:

FIG. 1 schematically shows a drive train device having an electric motor and a transmission,

FIG. 2 is a schematic diagram of the transmission,

FIG. 3 shows an alternative embodiment of the drive train device, and

FIG. 4 shows another alternative embodiment of the drive train device.

### DETAILED DESCRIPTION

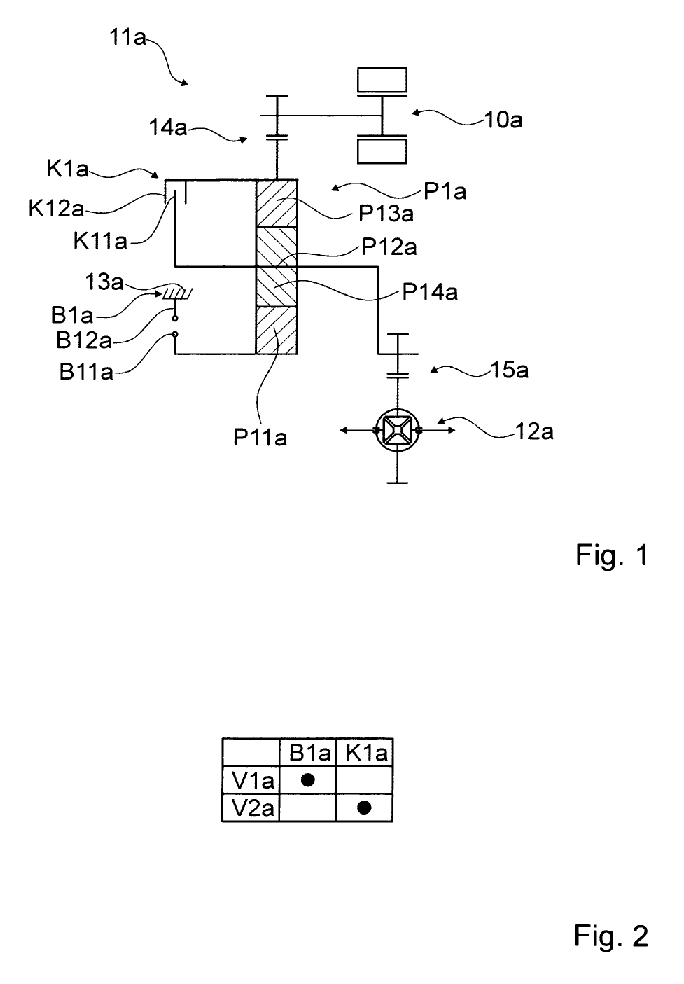

FIG. 1 shows a drive train device for a motor vehicle. The drive train device is provided for an electromotive drive of the motor vehicle. In principle, the motor vehicle can be designed merely as an electric vehicle. Alternatively, it is also conceivable for the drive train device to be provided for being combined with a drive train device for an internal combustion engine drive of the motor vehicle. For example, the proposed drive train device, which is provided for the electromotive drive, can act on a first drive axle of the motor vehicle, while the drive train device which is provided for the internal combustion engine drive acts on a second drive axle of the motor vehicle. If the proposed drive train device is combined with an internal combustion engine drive train device, it is also conceivable for the motor vehicle to comprise an additional summation gear and/or selective gear that is downstream of the two drive train devices and is provided for linking the two drive train devices to a single drive axle.

The drive train device comprises an electric motor 10a, a final drive 12a, and a transmission 11a that is arranged between the electric motor 10a and the final drive 12a. With respect to driving power generated by the electric motor 10a, the transmission 11a is arranged behind the electric motor 10a in the power flow. A power flow between the electric motor 10a and the final drive 12a is conducted completely through the transmission 11a.

The transmission 11a comprises a transmission housing 13a and exactly one planetary gear stage P1a arranged in the transmission housing 13a. The transmission 11a further comprises exactly one braking unit B1a having a rotatably mounted coupling element B11a and a coupling element B12a that is fixed to the housing, and exactly one clutch unit K1a having two rotatably arranged coupling elements K11a, K12a. The planetary gear stage P1a, in conjunction with the braking unit B1a and the clutch unit K1a, as shown in FIG. 2, is provided for selecting two gear ratios V1a, V2a. It is possible to power-shift between the gear ratios V1a, V2a.

The planetary gear stage P1a comprises a simple planetary gear set, and has a sun gear P11a, an internal gear P13a, and a planet carrier P12a. The planet carrier P12a guides one or more planet gears P14a on a circular path around the sun gear P11a. The planet gears P14a mesh with the sun gear P11a and with the internal gear P13a. The planet gears P14a are rotatably mounted on the planet carrier P12a.

The internal gear P13a is coupled to the electric motor 10a. The internal gear P13a forms an input element of the planetary gear stage P1a. The electric motor 10a is permanently coupled to the internal gear P13a. The planet carrier P12a is permanently coupled to the final drive 12a. The planet carrier P12a forms an output element of the planetary gear stage P1a.

The braking unit B1a is provided for non-rotatably coupling the sun gear P11a of the planetary gear stage P1a to the transmission housing 13a. The first coupling element B11a of the braking unit B1a is permanently connected to the sun gear P11a for conjoint rotation. The second coupling element B12a of the braking unit B1a is permanently non-rotatably connected to the transmission housing 13a. If the braking unit B1a is closed, the sun gear P11a of the planetary gear stage P1a is non-rotatably connected to the transmission housing 13a. The braking unit B1a is closed in the first gear ratio V1a. The clutch unit K1a is open in the first gear ratio V1a.

The clutch unit K1a is provided for locking the planetary gear stage P1a. The clutch unit K1a is provided for interconnecting the planet carrier P12a and the internal gear P13a of the planetary gear stage P1a for conjoint rotation. The first coupling element B11a of the clutch unit K1a is permanently connected to the planet carrier P12a for conjoint rotation. The second coupling element K12a of the clutch unit K1a is permanently connected to the internal gear P13a for conjoint rotation. If the clutch unit K1a is closed, the planetary gear stage P1a has a transmission ratio of 1. The clutch unit K1a is closed in the second gear ratio V2a. The braking unit B1a is open in the second gear ratio V2a.

The braking unit B1a is advantageously designed to engage interlockingly. The braking unit B1a is particularly advantageously designed without a synchronizer, because the overall design of the transmission 11a allows the braking unit B1a to be engaged sufficiently easily even without a synchronizer. In principle, however, the braking unit B1a can also be designed to engage interlockingly and to have a synchronizer, or to engage frictionally, for example in the form of a multi-plate clutch.

The clutch unit K1a is advantageously designed to engage frictionally, independently of how the braking unit B1a is designed. The coupling elements B11a, B12a of the braking unit B1a have mutually corresponding interlocking geometries, for example teeth or claws provided to mutually engage. In a closed state, the coupling elements B11a, B12a of the braking unit B1a are interlockingly interconnected. The coupling elements K11a, K12a of the clutch unit K1a are designed as mutually corresponding friction partners, or as supports for mutually corresponding friction elements. In a closed state, the coupling elements K11a, K12a of the clutch unit K1a are frictionally interconnected.

FIG. 2 is a schematic diagram of the transmission. When the gear ratio is changed from the first gear ratio Via to the second gear ratio V2a, the braking unit B1a is opened, and the clutch unit K1a is simultaneously closed. In order to change the gear ratio under load, the clutch unit K1a is closed gradually. Gradually closing the clutch unit K1a results in torque being gradually transferred from the braking unit B1a to the clutch unit K1a. If the braking unit B1a is free of load, it is opened, and the clutch unit K1a can be completely closed. Conversely, when the gear ratio is changed from the second gear ratio V2a to the first gear ratio Via, the clutch unit K1a is gradually opened first. The differential speed between the coupling elements B11a, B12a of the braking unit B1a therefore decreases. If the braking unit B1a has a synchronous speed, i.e., the sun gear P11a of the planetary gear stage P1a is stationary, then the braking unit B1a is closed.

In addition to the planetary gear stage P1a, the transmission 11a comprises two gear stages 14a, 15a. The first gear stage 14a is operatively arranged between the electric motor 10a and the planetary gear stage Pia. The first gear stage 14a comprises a first spur gear permanently connected to a rotor of the electric motor 10a for conjoint rotation, and a second spur gear designed to be permanently connected to the internal gear P13a for conjoint rotation, or to be integral with the internal gear P13a. The planetary gear stage P1a is integrated in the second spur gear of the first gear stage 14a.

The second gear stage 15a is operatively arranged between the planetary gear stage P1a and the final drive 12a. The second gear stage 15a comprises a first gearwheel permanently connected to the planet carrier P12a for conjoint rotation, which gearwheel can be designed in the form of a bevel gear or a spur gear as a driving pinion for the final drive 12a, for example. The second gear stage 15a comprises a second gearwheel which is associated with the final drive 12a and is designed as, for example, a ring gear.

In principle, the second gear stage 15a can be developed and designed as a further planetary gear stage (not shown). In the case of this development, the further planetary gear stage is designed as a planetary gear train. Advantageously, in the case of this development, the planet carrier P12a of the first planetary gear stage P1a is connected to a sun gear of the further planetary gear stage for conjoint rotation, an internal gear of the further planetary gear stage is non-rotatably connected to the transmission housing 13a and a planet carrier of the further planetary gear stage is connected to the second gearwheel, which is associated with the final drive 12a, for conjoint rotation.

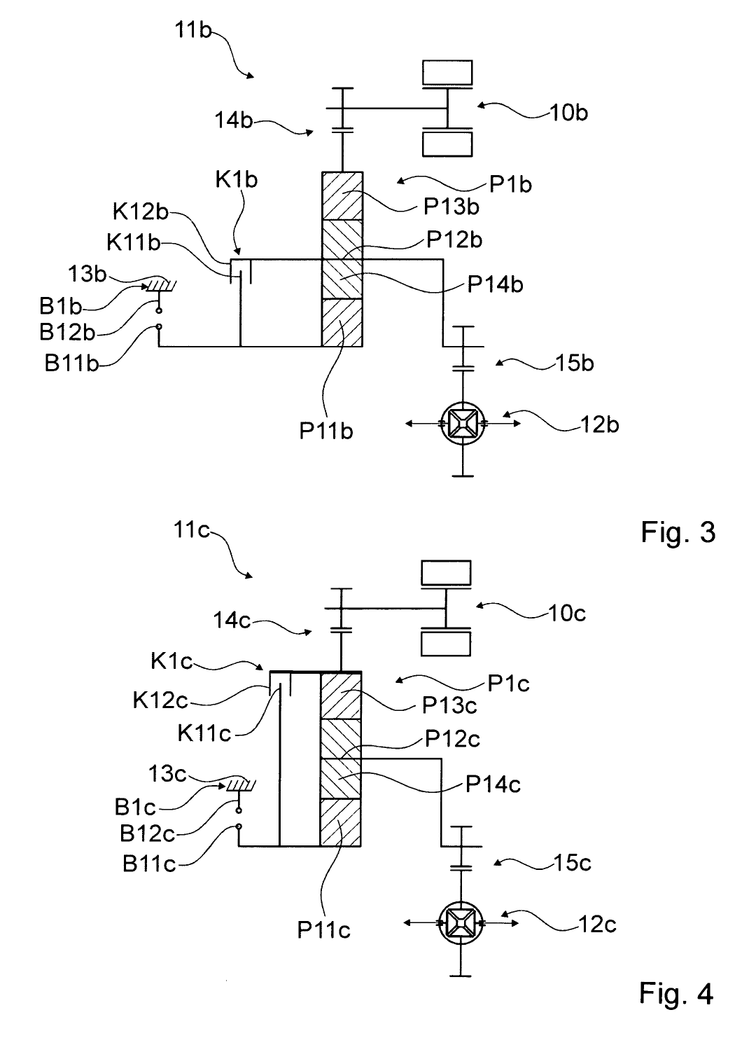

FIGS. 3 and 4 show two further embodiments of the invention. The following descriptions are substantially restricted to the differences between the embodiments, wherein reference can be made to the description of the other embodiments, in particular FIG. 1, with regard to identical components, features and functions. To differentiate between the embodiments, the letter a in the reference signs for the embodiment of FIG. 1 is replaced by the letters b and c in the reference signs for the embodiments of FIGS. 3 and 4. Reference can in principle also be made to the drawings and/or the description of the other embodiments, in particular FIG. 1, with regard to identically referenced components, in particular with regard to components with the same reference signs.

FIG. 3 shows an alternative embodiment of a drive train device. The drive train device comprises an electric motor 10b, a final drive 12b, and a transmission 11b arranged between the electric motor 10b and the final drive 12b. The transmission 11b comprises a first gear stage 14b, a planetary gear stage P1b and a second gear stage 15b. The planetary gear stage P1b comprises a sun gear P11b, a planet carrier P12b, planet gears P14b rotatably mounted on the planet carrier P12b, and an internal gear P13b. The transmission 11b additionally comprises a braking unit B1b having two coupling elements B11b, B12b and a clutch unit K1b having two coupling elements K11b, K12b. The braking unit B1b is provided for fixing the sun gear P11b to the housing for a first gear ratio. The clutch unit K1b is provided for locking the planetary gear stage P1b for a second gear ratio V2b. In contrast with the preceding embodiment, the first coupling element K11b is connected to the sun gear P11b. The second coupling element K12b is connected to the planet carrier P12b.

FIG. 4 shows another alternative embodiment of a drive train device. The drive train device comprises an electric motor 10c, a final drive 12c, and a transmission 11c arranged between the electric motor 10c and the final drive 12c. The transmission 11c comprises a first gear stage 14c, a planetary gear stage P1c and a second gear stage 15c. The planetary gear stage P1c comprises a sun gear P11c, a planet carrier P12c, planet gears P14c rotatably mounted on the planet carrier P12c, and an internal gear P13c. The transmission 11c additionally comprises a braking unit B1c having two coupling elements B11c, B12c and a clutch unit K1c having two coupling elements K11c, K12c. The braking unit B1c is provided for fixing the sun gear P11c to the housing for a first gear ratio. The clutch unit K1c is provided for locking the planetary gear stage P1c for a second gear ratio V2c. In contrast to the preceding embodiments, the first coupling element K11c is connected to the sun gear P11c. The second coupling element K12c is connected to the sun gear P11c.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE SIGNS

10 Electric motor
11 Transmission
12 Final drive
13 Transmission housing
14 Gear stage
15 Gear stage
B1 Braking unit
B11 Coupling element
B12 Coupling element
K1 Clutch unit
K11 Coupling element
K12 Coupling element
P1 Planetary gear stage
P11 Sun gear
P12 Planet carrier
P13 Internal gear
P14 Planet gears
V1 Gear ratio
V2 Gear ratio

1-11. (canceled)

12. A drive train device, comprising:
an electric motor;
a final drive; and
a transmission arranged between the electric motor and the final drive and configured to select for selecting two power-shiftable gear ratios, wherein the transmission comprises
exactly one planetary gear stage,
a braking unit,
a clutch unit,
a first gear stage operatively arranged between the electric motor 10a and the exactly one planetary gear stage and comprising a first spur gear permanently connected to a rotor of the electric motor for conjoint rotation, and a second spur gear be permanently connected to an internal gear of the exactly one planetary gear stage for conjoint rotation.

13. The drive train device of claim 12, wherein the exactly one planetary gear stage is integrated in the second spur gear of the first gear stage.

14. The drive train device of claim 12, wherein the internal gear has a form of a ring comprising teeth on an inner periphery forming the internal gear, and comprises teeth on an outer periphery thereof forming the second spur gear of the first gear stage.

15. The drive train device of claim 12, wherein the exactly one planetary gear stage comprises a planet carrier permanently coupled to the final drive.

16. The drive train device of claim 12, wherein the exactly one planetary gear stage comprises a sun gear and the braking unit is provided to fix the sun gear to a housing.

17. The drive train device of claim 12, wherein the clutch unit is configured to lock the exactly one planetary gear stage.

18. The drive train device of claim 17, wherein a coupling element of the clutch unit is arranged radially within an outer periphery of the internal gear.

19. The drive train device of claim 12, wherein the braking unit is configured to interlockingly engage.

20. The drive train device of claim 12, wherein the clutch unit is configured to frictionally engage.

21. The drive train device of claim 12, further comprising:
a second gear stage operatively arranged between the exactly one planetary gear stage and the final drive, and which comprises a first gearwheel permanently connected to the planet carrier for conjoint rotation, and a second gearwheel associated with the final drive.

22. The drive train device of claim 12, further comprising:
a second gear stage operatively arranged between the exactly one planetary gear stage and the final drive, and which comprises a further planetary gear stage arranged coaxially with respect to the exactly one planetary gear stage.
